(19) United States
(12) Patent Application Publication
(10) Pub. No.: US 2014/0269435 A1
(43) Pub. Date: Sep. 18, 2014

(54) Distributed Network Billing In A Datacenter Environment

(71) Applicants: Brad McConnell, Cibolo, TX (US); Erik Carlin, San Antonio, TX (US)

(72) Inventors: Brad McConnell, Cibolo, TX (US); Erik Carlin, San Antonio, TX (US)

(21) Appl. No.: 13/803,557

(22) Filed: Mar. 14, 2013

(51) Int. Cl. H04L 12/14

(52) U.S. Cl. CPC H04L 12/14
USPC 370/259

(57) ABSTRACT

Apparatus, systems and methods are provided for performing distributed network billing in a datacenter environment. The method includes receiving a network packet including a destination identifier in a virtual switch from a virtual machine of a server of a datacenter associated with a customer of the datacenter, determining if the destination identifier is present in an accounting list of the virtual switch that includes destination identifiers each associated with a first billing rate, and if so, updating a counter associated with the accounting list according to a size of the network packet.

### BACKGROUND

Today, in a datacenter environment bandwidth billing is performed in a very coarse-grained manner. Bandwidth statistics are collected from a switch port or virtual interface attached to a virtual machine (VM). Interfaces are either billed or free, but all traffic on a billed interface must be billed at the same rate. Thus whether a VM communicates with the VM next to it, a server in another datacenter region of the same service provider, or a system on the public Internet, the traffic is billed at the same rate regardless of destination.

This billing operation does not reflect the true costs required to carry the traffic, since the true cost to transfer traffic progressively increases as it transits within a datacenter, between different datacenters of a service provider over dedicated circuits, or to the Internet.

### SUMMARY OF THE INVENTION

In an embodiment, a method for performing distributed network billing in a datacenter environment may take the following form. Note that this method may be implemented in various hardware, firmware, and/or software of the datacenter, and can leverage information obtained from distributed sources to generate billing information for a datacenter customer with reduced complexity. As one such example, the method may be implemented in a computer readable medium that includes instructions that enable one or more systems of the datacenter to perform the distributed network billing operations.

The method includes receiving a network packet including a destination identifier in a virtual switch from a virtual machine of a server of the datacenter associated with a customer of the datacenter, determining if the destination identifier is present in an accounting list of the virtual switch that includes destination identifiers each associated with a first billing rate, and if so, updating a counter associated with the accounting list according to a size of the network packet.

In an embodiment, the method includes updating a second counter associated with a default billing rate according to the size of the network packet if the destination identifier is not present in any accounting list. In addition, an announcement of a route to a network block of a second datacenter coupled to the datacenter via a network backbone is received, where the announcement includes a message having a destination identifier of the network block, a route to the network block, and a billing tag associated with the destination identifier, and a list of routes in a route server of the datacenter is updated with an entry based on the message information.

Still further the method may include processing information from an entry of the list of routes to generate aggregated route information and populating an entry in a local route database with the aggregated route information and the billing tag, and updating a first accounting list of a middleware server of the datacenter, where the first accounting list is for a billing rate corresponding to the billing tag of the aggregated route information.

Another aspect is directed to a system for performing the distributed billing. More specifically, this system is a distributed billing system for a multi-tenant datacenter having a plurality of datacenter regions.

One such region includes a local route server to receive route messages and to update one or more routing tables based on the route messages, where each of the route messages includes a destination identifier to identify a network block and a billing tag to be associated with a billing rate to be applied to traffic destined to the network block. The region also includes an integration sever coupled to the route server to receive and process the destination identifier and the billing tag to generate an entry for storage in one of multiple accounting lists of the integration server, where each of the accounting lists is associated with a billing rate corresponding to the billing tag. Also, the region includes a software defined network (SDN) controller or other cluster controller coupled to the integration server to receive updates to the accounting lists and to send the updates to a plurality of virtual switches, where the virtual switches each include counters each to count network traffic destined to a location present on an accounting list of the virtual switch.

The region may also include one or more billing servers coupled to the SDN controller to communicate a request for billing information of a first customer of the multi-tenant datacenter via the distributed billing system, where the billing server is to receive count values responsive to a query from the SDN controller to one or more switches coupled to virtual machines associated with the first customer, where the count values are each associated with an accounting list of one or more virtual switches associated with the first customer.

### BRIEF DESCRIPTION OF THE DRAWINGS

FIG. 1 is a block diagram of an overall view of a system in accordance with an embodiment of the present invention.

FIG. 2 is a flow diagram of a method for propagating billing tag information in accordance with an embodiment of the present invention.

FIG. 3 is a flow diagram of a method for propagating billing tag information to various entities of a datacenter in accordance with an embodiment of the present invention.

FIG. 4 is a flow diagram of a method for updating traffic monitoring information for a given virtual machine in accordance with an embodiment of the present invention.

FIG. 5 is a flow diagram of method for performing distributed billing in accordance with an embodiment of the present invention.

### DETAILED DESCRIPTION

Using an embodiment of the present invention, data traffic can be billed at different rates depending upon different network destinations of the traffic. Still further, embodiments provide for automatic updates to traffic destinations based upon real-time information extracted from the datacenter network. Thus dynamic changes to datacenter infrastructure can be reflected in billing functions in a transparent and autonomous manner. In addition, billing operations can be done in a distributed manner such that the overhead cost of billing is reduced.

In this way, a service provider can offer granular billing based upon which links the customer's traffic travels. Embodiments can automatically account for the dynamic nature of datacenter networks, where many new routes are added on a daily basis. Such new routes can automatically be associated with the appropriate billing rate based upon route tagging at announcement source.

Using an embodiment, the need to collect statistical data for every packet via routers throughout the datacenter and report these statistics to a central data aggregation point (normally via an sFlow or netflow protocol) can be avoided. In this conventional system the aggregation point then processes all of the incoming data in order to derive the actual amount of data transiting between any two end stations. The majority of hardware deployed cannot provide complete statistical data for every packet, so the resulting data is not at a sufficiently high resolution to be used for financial purposes such as billing. Collecting and processing this data is not a scalable approach for large datacenters with dense virtualization, due to the sheer volume of IP addresses generating data and the volume of network resources being used. Embodiments thus resolve this problem by shifting to a distributed model, where every host calculates the bandwidth consumption for any locally running VMs and exposes that information via an application programming interface (API) for a billing system to collect.

Referring now to FIG. 1, shown is a block diagram of an overall view of a system in accordance with an embodiment of the present invention. As shown in FIG. 1, system 100 is a network view of a distributed network 100 which includes components of multiple datacenters of a service provider such as a cloud service and/or hosted service provider. In general, components shown below a backbone 120 of this network 100 may be of a local datacenter, while the components coupled above backbone 120 may be of a remote datacenter. Specifically as illustrated in FIG. 1, a route server 125 of a remote datacenter is present. In general, a datacenter may include a set of route servers that are used to generate and maintain local routing tables that are used to identify routes to destination network blocks within the local datacenter. These local network tables may be propagated across route servers of all of the datacenters of the service provider such that a complete set of routing tables that provides the routes to all destinations of the service provider is realized.

A route, which is an identification of a path to a destination network block, is propagated outward from its point of origination. Certain routing protocols, such as the border gate protocol (BGP), allow routes to be tagged with one or more tags at any point within the BGP routing domain. These tags can be used to express common traits about the routes (such as geographical location). Using an embodiment, routes may be tagged, e.g., at their creation point (within a route server) with a billing tag. In an embodiment, this billing tag may be associated with a general location of the network block. In an embodiment, route tags may be integers, though in some cases the tags may take on different formats to be more human readable. Of course other routing protocols may be used, as described below.

As one example, assume a service provider has a datacenter in each of multiple regions. For purposes of discussion, assume a first datacenter is located in Chicago (ORD) and a second datacenter is located in Dallas (DFW). If all major network blocks are announced out of ORD1 with routes having a common tag, and traffic between ORD1 and DFW1 costs the service provider a certain rate (e.g., $4/Mbps) to transfer data, the remote datacenter can use the tag of the routes to determine which IP ranges local customers might transfer data to. If another route is added to the first datacenter later, the second datacenter does not need any configuration update—it continues to look for routes with a given tag and simply finds a new route in the list.

By combining the near real-time convergence of routing protocols that support route tagging with a scalable, configurable IP accounting system, more advanced customer billing can occur. To this end, each datacenter may include one or more middleware servers (referred to herein as integration servers) including logic configured as an application to determine association of billing rates with corresponding billing tags of route information. In a basic implementation, the logic can determine that all routes from a given remote datacenter to a local datacenter (e.g., ORD1 to DFW1) be billed at the same rate. However, understand that the scope of the present invention is not limited in this regard, and in other embodiments different billing rates can be applied to different billing tags of the same datacenter, e.g., discrete billing rates for given destinations in a remote DC at a product level granularity, or in order to support an agreed upon contracted rate for a third party service hosted within the datacenter.

As will be described herein, when a routing server generates a new route, a tag is associated with the route. More specifically, this billing tag provides an identification associated with a destination of the route (e.g., to the corresponding network block). In turn this billing tag can be used to enable a billing rate to be associated with this tag as described herein. Note that with the route information itself, this billing tag may be propagated throughout the distributed network. Thus routes originating in remote route server 125 may be propagated through backbone 120 to a route server 110 of a local datacenter.

Still referring to FIG. 1, route server 110 is coupled to an integration server 130. Note that although for ease of illustration only a single integration server is shown, understand that in various embodiments each datacenter may include a set of integration servers. As will be described herein, integration server 130 may obtain certain information from the routing information and use it to generate so-called buckets or accounting lists that identify a set of routes that are associated with a particular billing rate. In addition to receiving and processing new routes, the logic can update a database with the new route information. Still further, the logic analyzes the local routing table and searches for all routes having a common billing tag (e.g., RAX:ORD1) and groups them together. The resulting list of routes then represents a billing profile for all destinations that are billed at a given rate, such as $0.02/GB. This list of routes can be propagated as accounting lists to other entities of the local datacenter. More specifically, the integration server may communicate accounting lists (or updates thereto) to a software defined network (SDN) controller cluster or other controller cluster that in turn can be in communication with virtual machines (more particularly to virtual switches of the VMs) to update corresponding accounting lists associated with each logical port of the virtual switch.

Thus as further shown in FIG. 1, integration server 130 is coupled to a SDN controller 140. In general, SDN controller 140 is a cluster that can be implemented via a set of servers or other compute devices. All software switches are managed by a single, datacenter-wide collection of servers, namely this set of SDN controllers. This is a single point of network orchestration where the integration server can report its collection of lists that contain the network destination-billing rate associations relevant to VMs in the local datacenter. The controller cluster can then push these lists downstream to every logical switch port that is to be billed bandwidth charges. The controller cluster has the ability to create, update, or delete the billing lists associated with any port, as well as the ability to query individual counters for any billing rate associated with a VM's logical switch port. This provides billing departments a centralized location to query for data in order to create a customer's (tenant's) bandwidth bill. Thus based on the accounting lists generated in integration server 130, SDN controller 140 can maintain a set of accounting lists, one for each bucket or billing rate. Note that a cluster could also service only a subset of a datacenter. Thus an integration server is capable of announcing its resultant lists to multiple destinations (e.g., SDN controllers 1 through n in a given DC and/or some non-SDN network services API that interacts with downstream networking devices).

Alternative example controller clusters may include vendor-specific network APIs or other services that interact with switches and routers. In an embodiment, the controller may be accessed through an abstracted API, which in an embodiment may be the Openstack Quantum API. Quantum has backend plugins that interact with different networking APIs. Thus part of a datacenter may use an SDN controller plugin and a different portion of the datacenter uses traditional switches supported through a separate plugin. In both cases, the integration server interacts with a single API (Quantum) but can still advertise new or updated accounting lists to ports that are associated with both virtual switches as written and physical switch ports.

In turn, these accounting lists can further be propagated to switches to which are coupled VMs that execute on servers 150. Note that while only a single server is shown, understand that in a given embodiment a datacenter can include a set, e.g., a large number of such servers. As is well known, each server may host a plurality of virtual machines, each having a hypervisor and configured to communicate with other entities via a virtual switch that in turn may include a number of logical switch ports. For example, within a cloud server system, every physical server runs multiple virtual machines. These virtual machines interact with the physical network via a virtual software switch that runs within the server. Each virtual machine connects to an individually configurable virtual port on a software switch that can be queried for traffic statistics.

By placing a list of routes onto the virtual port and allowing traffic to pass, a count of the bytes of data that are directed to any destination on this list may be generated as the traffic passes. From this count an accurate billing profile for traffic of a particular billing rate for the VM can be maintained. Traffic that does not match any list for the port can be billed at either another rate for a destination found in another list, or at a default rate. Thus in an embodiment, each virtual switch may include a set of counters, where each counter is associated with a given accounting list (that in turn is associated with a particular billing rate).

Thus these virtual ports are programmed with the accounting lists. In this way, when packets are to be sent from a VM through a given virtual switch, a count can be updated for the type of traffic (e.g., corresponding to a given billing rate). Given this information regarding the rate at which traffic to a given destination is to be billed, per-VM statistics may be collected. More specifically, a counter may be associated with each accounting list (each of which may include destination identifiers for destination locations to be charged at a common billing rate). This counter is configured to count how much traffic is being directed from the corresponding logical port to a given set of destinations. In an embodiment, the counter is configured as a byte counter to count bytes communicated. Although shown at this high level in the embodiment of FIG. 1, understand that other implementations are possible.

Consider now a scenario where a new major route is added to a first datacenter (e.g., ORD1) and how a dynamical change to the billing profile for that route in a second datacenter (e.g., DFW1) VM occurs. A major route (e.g., an aggregate route) is a summarization of multiple smaller routes contained within the datacenter. As an example, the route 10.1.0.0/16 is advertised out to the Internet. This encompasses every IP address from 10.1.0.0 to 10.1.255.255-65,000+ IP addresses. Within the datacenter this block could be broken up into 256 IP blocks that each hold 256 IPs each, but other datacenters and Internet peering points do not need that level of knowledge, and simply need to know that all 65,000 IPs are reached via the same datacenter. By tagging the aggregates, marking of every destination in a DC is effected while affecting a minimal amount of change/tagging into the network.

Assume that this new route, identified as 10.1.1.0/24, is advertised out of ORD1. A routing server in the local datacenter, using pre-defined policies, tags the route with a billing tag (simplified here as RAX:ORD1). This route is advertised over a backbone to other service provider facilities and arrives in DFW1 with the tag intact. An integration server that peers with the local route server scans for any RAX:ORD1 routes and assembles a list. The server then uses common IP libraries to aggregate the routes to the minimal number of routes and populates a local database with the results. This database may be monitored, e.g., by a separate process executing on the server, for changes. When the new route is discovered, it is added to a pre-defined bucket or accounting list of routes that are billed at a uniform rate. Next, the integration server updates or replaces a copy of this access list on a SDN controller. The SDN controller then automatically pushes the update or replaces the new list to all downstream software switches, which updates the list on any ports configured to participate in that accounting list.

Then the next time any of the VMs that have the list configured with the update send traffic to a destination within the network block corresponding to this route (e.g., 10.1.1.0/24), the counter associated with the list is updated. Since this counter can be queried, the next time the VM reaches the end of a billing cycle, a billing system can query the absolute value of the counter for the access list on the VM's logical switch port, apply the appropriate rate for traffic within this list, and add it to the total bill. The counter can then be reset so it can begin incrementing for the next billing cycle. Another method is to never reset the counters, but maintain a historical record of the counter at various intervals in an external system and bill based upon the value's delta from one period to another.

Referring now to FIG. 2, shown is a flow diagram of a method for propagating billing tag information in accordance with an embodiment of the present invention. As shown in FIG. 2, method 200, which may be performed by a combination of hardware, software and/or firmware in various locations of one or more datacenters, begins at block 210 by receiving an announcement of a new route. More specifically, this new route announcement is of a network block of a first datacenter. Assume for purposes of discussion that this first datacenter is of a service provider and is located in a first region (e.g., Chicago (ORD1)). This announcement may be by way of a message that associates a route to this network block with a corresponding billing tag. Such route announcements can be sent throughout different datacenters of the service provider, e.g., via a network backbone, such that they are received in route servers of the different datacenters.

Assume for purposes of the discussion of FIG. 2 that this first datacenter is a remote datacenter and that the announcement is received in a route server of a second, local datacenter in a second region (e.g., Dallas, DFW). Based on this announcement, the local route server may update its routing tables to include this additional route information, e.g., as another entry of the route table (block 220). For example, each set of route servers of a datacenter may include running lists that provide this information including routes through network blocks and corresponding billing tags. And, these local route servers act to advertise all major network routes that the service provider hosts, globally.

In addition, this routing table information can be analyzed by other entities of the datacenter. For example, an integration server may peer this route server to thus obtain updates. In an embodiment, the integration server receives routes from the network via a dynamic protocol such as BGP (or an open shortest path first (OSFP) or intermediate system to intermediate system (IS-IS) protocol) that include pre-configured tags that are added to the individual routes at their source of advertisement. Note that more generally a tag is an attribute or distinct piece of metadata that can be applied to a route and later referenced by another system. This could be an integer in the case of a routing protocol tag, a BGP community, or any similar transitive property. The integration server scans through all routes according to pre-configuration to only care about routes that have specific tags (or metadata) assigned, and groups them based upon tags to generate a set of lists. Example routes are shown in Table 1 below. Since different tags translate into different billing costs per bandwidth, tags may be enumerated equal to the level of discrete destination costs. For tracking purposes, the enumeration may be more discrete than needed for billing (for instance, if DFW and ORD both bill at the same rate per GB, their lists may be concatenated for billing, yet they are still tagged separately to track where customers are sending data).

TABLE 1

Routes from DFW:
10.1.0.0/16 tag 1
10.2.0.0/16 tag 1
Routes from ORD:
20.1.0.0/16 tag 2
20.2.0.0/16 tag 2

Still referring to FIG. 2, in addition to obtaining updates, the integration server may further process the information (block 230). More specifically, the route information may be processed to generate an aggregated route. That is, the route information, via IP address tables can be aggregated such that the route information is summarized or abstracted to a larger network block to thus reduce the number of entries present in a local route database, which may be present within the integration server. In an embodiment, the integration server may be configured to execute according to the pseudo code of Table 2 below:

TABLE 2

for tag in x, y, z:
collect_routes;
aggregate_routes;
store_routes;

Thus in general, the integration server collects routes, aggregates them to larger network constructs, and stores them for later update to the set of SDN controllers. Although shown at this high level in the embodiment of FIG. 2, understand that various alternatives are possible.

Referring now to FIG. 3, shown is a flow diagram of a method for propagating billing tag information to various entities of the datacenter in accordance with an embodiment of the present invention. As shown in FIG. 3, method 300 may be implemented within various logic of a datacenter to thus provide a mechanism to enable traffic communicated from VMs within the datacenter to be associated with particular billing rates. More specifically as seen in FIG. 3, method 300 begins by determining whether an update has occurred to a local route database (diamond 310). In an embodiment, this determination may be performed using logic such as an application that executes on the integration server, which analyzes the local route database to determine whether any updates have occurred according to an interrupt-driven event. Note that in other embodiments, rather than being interrupt driven at some scheduled interval the assembled lists in the integration server can be checked to see if the accounting lists in the SDN controller require updating.

If so, control passes to block 320 where an accounting list can be updated based on this new route information. More specifically, the integration server may maintain a set of accounting lists, each associated with a particular billing rate. Note that this accounting list may be of an integration server that peers with the local route servers to determine whether an update has occurred. This billing rate may correspond also to a particular tag or set of tags that are associated with the route information. Thus the corresponding accounting list for an updated route entry having the matching tag may thus be updated at block 320. Thus this integration server provides an entry into its accounting list for a billing rate corresponding to the billing tag of the route information. Control next passes to block 330 where this updated accounting list can be passed to an SDN controller. In some embodiments the entire accounting list can be sent on an update, while in other embodiments only the updated entry itself is communicated.

Finally at block 340, the information from the SDN controller can be distributed to various virtual machines of the datacenter. More specifically this same updated accounting list information can be applied to one or more logical ports of virtual machines within the local datacenter. In an embodiment, each logical port of a virtual switch (or hardware switch) stores a set of accounting lists, each list associated with a different billing rate. As such, accurate network traffic information for traffic being communicated from the VM through a given logical port can be obtained.

Referring now to FIG. 4, shown is a flow diagram of a method for updating traffic monitoring information for a given virtual machine in accordance with an embodiment of the present invention. As shown in FIG. 4, method 400 may be implemented, e.g., via a logic of a VM, logical port associated with the VM, or a logical switch associated with the logical port. As seen, method 400 begins by receiving a network packet in a virtual switch from a given logical port of a VM (block 410). Such network packet may be of a given length (e.g., in bytes) and destined to a corresponding network location that may either be within the same server, within the same datacenter (such as a common huddle with the VM or a different zone), or to a different datacenter of the network service provider in a different region. Still further, traffic may be destined more generally to the Internet.

Next control passes to diamond 420 where it can be determined whether a destination identifier of this network packet is present in an accounting list stored in the logical port. If so, control passes to block 430 where a counter for the accounting list can be updated according to the packet size of the packet (block 430). For example, in an implementation in which a byte counter is associated with each accounting list, the corresponding byte counter is updated based on the size of the packet. For example, assume a 9000 byte packet, the counter can be updated accordingly. In some embodiments the byte counter may count in units of bytes, while in other embodiments different units of measure can be used.

Note that if the destination identifier for the outgoing packet is not present in any of the accounting lists of the logical port, control passes to block 440 where another counter that is associated with a default billing rate (e.g., an Internet billing rate) is updated according to the packet size. Note that in yet other embodiments, rather than applying a default billing rate, a rate of another one of the accounting lists can be used by updating that counter. Accordingly, this default billing rate may accommodate locations that have yet to be included in an accounting list for whatever reason.

Referring now to FIG. 5, shown is a flow diagram of method for performing distributed billing in accordance with an embodiment of the present invention. As shown in FIG. 5, method 500 may be performed by various logic within a datacenter including the components discussed above. In addition, at least certain operations may be performed by components of a billing system, which can be implemented within one or more servers of the datacenter, such as backend systems. In general, the billing system may operate by querying various entities of the datacenter to obtain information regarding utilization of resources for a particular customer and to generate a bill for that customer based on their usage. In one embodiment, actual traffic counters per virtual machine may be queried by initiating communication from billing system to a networking API that exposes virtual switches and ports that VMs connect to the SDN controller, and finally to the switch. As another example, communications may be queried from billing system directly to SDN controller to switch.

As seen in FIG. 5, method 500 begins by receiving a billing request from a billing system for a particular customer (block 510). In this embodiment, this request is received in an SDN controller from the billing backend. Responsive to this request, control passes to block 520 where the SDN controller can communicate a query to a set of switches coupled to virtual machines that are associated with the customer. Then responsive to this query, count values can be received from the switches (block 530). More specifically, each switch includes multiple sets of counters, each set associated with a given logical port through which the switch couples to a VM. The values of these sets of counters for the different logical ports of the VM can be communicated (e.g., each associated with a given accounting list and thus corresponding billing rate). Or in some embodiments, logic may be present within the virtual switch itself to enable a first level of aggregation to occur at the VM level such that the set of counters of different logical ports of the VM can be aggregated for a particular billing rate before that count information is communicated to the SDN controller.

Still referring to FIG. 5, next at block 540 the count values can be communicated to the billing system. In turn, at the billing system these count values can be aggregated (block 550). More specifically, for each billing rate, the count values can be aggregated such that a total count value (e.g., in terms of bytes) for each billing rate for the given customer is generated. Then the billing system may apply the corresponding traffic billing rate to this aggregate count value for each of the aggregate counts to generate a resulting data traffic bill. Although shown at this high level in the above figures, understand that various additional features and alternatives are possible.

One alternate method of communicating billing/usage data is for the switch software itself to be configured to publish events at regular intervals to a publisher/subscriber system. In this way, if different consumers (e.g., network operations, billing, and resource planning) would all like to see the same data, each system need not query every software switch for usage metrics. In this model, they all subscribe to a live feed that allows them consume the events that every logical switch publishes.

Note that while the routes are layer 3 (IP destinations), the accounting lists have more granularity. For instance, if a datacenter allocates all user datagram protocol (UDP) traffic to be free, the integration system could be made aware of this policy. In this case, the accounting lists would be assembled and ordered such as this: count udp traffic to destination 1; and count IP traffic to destination 1. This separates the more specific UDP traffic from the less specific IP traffic for a given destination. The billing system could then discard all the UDP counters and only bill based upon the IP line, making the UDP traffic free.

Embodiments may be implemented in code and may be stored on a storage medium having stored thereon instructions which can be used to program a system to perform the instructions. The storage medium may include, but is not limited to, any type of non-transitory storage medium suitable for storing electronic instructions.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
receiving a network packet including a destination identifier in a virtual switch from a virtual machine of a server of a datacenter, the virtual machine associated with a customer of the datacenter;
determining if the destination identifier is present in an accounting list of the virtual switch, wherein the accounting list includes a plurality of destination identifiers each associated with a first billing rate; and
if so, updating a counter associated with the accounting list according to a size of the network packet.

2. The method of claim 1, further comprising updating a second counter associated with a default billing rate according to the size of the network packet if the destination identifier is not present in any accounting list.

3. The method of claim 1, further comprising:
receiving an announcement of a route to a network block of a second datacenter coupled to the datacenter via a network backbone, the announcement including a message having a destination identifier of the network block, a route to the network block, and a billing tag associated with the destination identifier; and
updating a list of routes in a route server of the datacenter with an entry based on the message information.

4. The method of claim 3, further comprising:
processing information from entry of the list of routes to generate aggregated route information and populating an entry in a local route database with the aggregated route information and the billing tag; and
updating a first accounting list of a middleware server of the datacenter, the first accounting list for a billing rate corresponding to the billing tag of the aggregated route information.

5. The method of claim 4, further comprising updating an accounting list of the logical port with the destination identifier obtained from the first accounting list of the middleware server.

6. The method of claim 5, further comprising receiving a billing request for the customer from a billing system of the datacenter in a software defined network (SDN) controller.

7. The method of claim 6, further comprising:
responsive to the billing request, communicating from the SDN controller a query to one or more switches coupled to virtual machines associated with the customer; and
receiving in the SDN controller of the count values each associated with an accounting list from the one or more switches.

8. The method of claim 7, further comprising communicating the count values to the billing system.

9. The method of claim 8, further comprising aggregating the count values per billing rate and applying the corresponding billing rate to each of the aggregated count values to generate a data traffic bill for the customer.

10. A system comprising:
a distributed billing system for a multi-tenant datacenter having a plurality of datacenter regions, wherein a first datacenter region includes:
a local route server to receive route messages and to update one or more routing tables based on the route messages, each of the route messages including a destination identifier to identify a network block and a billing tag to be associated with a billing rate to be applied to traffic destined to the network block;
an integration sever coupled to the route server to receive and process the destination identifier and the billing tag to generate an entry for storage in one of a plurality of accounting lists of the integration server, each of the plurality of accounting lists associated with a billing rate corresponds to the billing tag;
a software defined network (SDN) controller coupled to the integration server to receive updates to the plurality of accounting lists and to send the updates to a plurality of virtual switches; and
the plurality of virtual switches coupled to the SDN controller, each of the plurality of virtual switches including a plurality of counters, each to count network traffic destined to a location present on an accounting list of the virtual switch.

11. The system of claim 10, further comprising a billing server coupled to the SDN controller to communicate a request for billing information of a first customer of the multi-tenant datacenter via the distributed billing system.

12. The system of claim 11, wherein the billing server is to receive count values responsive to a query from the SDN controller to one or more switches coupled to virtual machines associated with the first customer, wherein the count values are each associated with an accounting list of one or more virtual switches associated with the first customer.

13. The system of claim 12, wherein a first virtual switch of the one or more virtual switches is to receive a network packet including a destination identifier from a virtual machine associated with the first customer, determine if the destination identifier is present in a first accounting list of the first virtual switch, the first accounting list including a plurality of destination identifiers each associated with a first billing rate, and if so, update a counter associated with the first accounting list according to a packet size of the network packet.

14. The system of claim 13, wherein the first virtual switch is to update a second counter associated with a default billing rate according to the packet size of the network packet if the destination identifier is not present in any accounting list of the virtual switch associated with any billing rate.

15. The system of claim 10, wherein the local route server is to receive an announcement of a route to a network block of a second datacenter coupled to the datacenter via a network backbone, the announcement including a message having a destination identifier of the network block, a route to the network block, and a billing tag associated with the destination identifier, and update a list of routes in the local route server with an entry based on the message information.

16. An article comprising a computer-readable storage medium comprising instructions to:
receive a network packet including a destination identifier in a virtual switch from a virtual machine of a server of a datacenter, the virtual machine associated with a customer of the datacenter;
determine if the destination identifier is present in an accounting list of the virtual switch, wherein the accounting list includes a plurality of destination identifiers each associated with a first billing rate; and
if so, update a counter associated with the accounting list according to a size of the network packet.

17. The article of claim 16, further comprising instructions to update a second counter associated with a default billing rate according to the size of the network packet if the destination identifier is not present in any accounting list.

18. The article of claim 16, further comprising instructions to:
receive an announcement of a route to a network block of a second datacenter coupled to the datacenter via a network backbone, the announcement including a message having a destination identifier of the network block, a route to the network block, and a billing tag associated with the destination identifier; and
update a list of routes in a route server of the datacenter with an entry based on the message information.

19. The article of claim 16, further comprising instructions to:
process information from entry of the list of routes to generate aggregated route information and populating an entry in a local route database with the aggregated route information and the billing tag; and
update a first accounting list of a middleware server of the datacenter, the first accounting list for a billing rate corresponding to the billing tag of the aggregated route information.

20. The article of claim 19, further comprising instructions to update an accounting list of the logical port with the destination identifier obtained from the first accounting list of the middleware server.
